(19) United States
(12) Patent Application Publication
(10) Pub. No.: US 2012/0056095 A1
(43) Pub. Date: Mar. 8, 2012

(54) COLLIMATION APPARATUS FOR HIGH RESOLUTION IMAGING

(76) Inventors: Scott METZLER, Haddonfield, NJ (US); Joel S. Karp, Glenside, PA (US)

(21) Appl. No.: 12/875,664

(22) Filed: Sep. 3, 2010

(51) Int. Cl. G21K 1/02; B23P 17/04

(52) U.S. Cl. 250/363.1; 250/505.1; 29/428

(57) ABSTRACT

The invention relates to a collimation apparatus for use in biomedical imaging systems. Specifically, the invention relates to a collimation apparatus that blocks a portion of its crystal with a radiation blocking element.

### FIELD OF THE INVENTION

The invention relates to a collimation apparatus for use in biomedical imaging systems. Specifically, the invention relates to a collimation apparatus that blocks a portion of its crystal with a radiation blocking element.

### BACKGROUND OF THE INVENTION

The resolution of a reconstructed PET image is limited by the effects of positron range and acollinearity, the depth-of-interaction effect, which limits the interaction-point determination, sampling, and the detector pixel size. One way to improve the resolution is to decrease the detector element size. This may be achieved by physically making the pixels smaller, or blocking some portion of the pixels with a septum, hence reducing their cross sectional dimensions as seen by the incoming photons.

Using septa would also result in a loss of the efficiency of the system, but the gain in resolution would still yield images with better contrast and noise recovery, especially in imaging scenarios which would allow longer scan time to make for the efficiency loss.

In emission tomography, the observed activity inside a fine structure of the object appears to be lower than its real value, which is known as the Partial Volume Effect, due to the finite resolution of an imaging system. Therefore, an imaging system with better system resolution would result in more accurate characterization of the radioactivity in a specific region of interest, if all other things are equal. In addition, in cases where the lesion to surrounding tissue uptake ratio is small, the lesion detection is improved due to better Contrast Recovery as a result of better system resolution, if all other things are equal.

Accordingly, there exists a need to improve quantification and detection capabilities for a PET system.

### SUMMARY OF THE INVENTION

In one embodiment, the invention provides a collimation apparatus comprising: a first ring comprising an array of crystals and a second ring comprising an array of radiation blocking elements, wherein said second ring is disposed inside said first ring, and wherein a portion of each crystal of said array of crystals is blocked by a radiation blocking element of said array of radiation blocking elements.

In another embodiment, the invention provides a positron emission tomography (PET) scanner comprising a collimation apparatus, said collimation apparatus comprising: a first ring comprising an array of crystals and a second ring comprising an array of radiation blocking elements, wherein said second ring is disposed inside said first ring, and wherein a portion of each crystal of said array of crystals is blocked by a radiation blocking element of said array of radiation blocking elements.

In another embodiment, the invention provides a method of fabricating a collimation apparatus comprising: providing a first ring comprising an array of crystals; and providing a second ring comprising an array of radiation blocking elements, said second ring disposed inside said first ring, wherein a portion of each crystal of said array of crystals is blocked by a radiation blocking element of said array of radiation blocking elements.

In another embodiment, the invention provides a method for imaging a subject, the method comprising, providing a collimation apparatus, said collimation apparatus comprising: a first ring comprising an array of crystals and a second ring comprising an array of radiation blocking elements, wherein said second ring is disposed inside said first ring, and wherein a portion of each crystal of said array of crystals is blocked by a radiation blocking element of said array of radiation blocking elements.

In another embodiment, the invention provides a method for improving a resolution of an image of a scanner, the method comprising, providing a collimation apparatus, said collimation apparatus comprising: a first ring comprising an array of crystals and a second ring comprising an array of radiation blocking elements, wherein said second ring is disposed inside said first ring, and wherein a portion of each crystal of said array of crystals is blocked by a radiation blocking element of said array of radiation blocking elements.

Other features and advantages of the present invention will become apparent from the following detailed description examples and figures. It should be understood, however, that the detailed description and the specific examples while indicating preferred embodiments of the invention are given by way of illustration only, since various changes and modifications within the spirit and scope of the invention will become apparent to those skilled in the art from this detailed description.

### BRIEF DESCRIPTION OF THE FIGURES

FIG. 1. (a) A schematic view of the simulated small-animal PET ring (collimator configuration number 3 is shown (See Table I)). Tungsten septa are dark gray (inner ring) and light gray represents the LYSO crystals (outer ring). The ring diameter for the LYSO crystals was 205 mm. (b) A close up view of the PET ring showing the septa covering the left half of the LYSO crystals transaxially.

FIG. 2. Simulated 0.5 (a), 1 (b), 2 (c), and 3 (c) mm lesion phantoms are shown. Each phantom had three hot lesions (center, 12, and 3 o'clock) and one cold lesion (9 o'clock) with a uniform warm background.

FIG. 3. The sampling map shows all possible and visited LORs during a scan with eight collimation configuration. Central 30 mm diameter FOV is marked with two solid black lines. ρ is the radial distance, and φ is the angular orientation of a LOR.

FIG. 4. The reconstructed images of a uniform activity cylinder phantom, scanned with the collimated PET system, with (left column) and without (right column) the efficiency non-uniformity correction are shown. Bottom row shows the profiles through the centers.

FIG. 5. Reconstructed images for phantom with lesion diameters of 0.5 (top row), 1 (2^{nd} row), 2 (3^{rd} row), and 3 mm (bottom row) are shown. Each phantom was scanned with non-collimated PET (left column) for a scan time of t, and with collimated PET for scan times of t (2^{nd} column), 2t (3^{rd} column), 4t (4^{th} column), 8t (right column).

FIG. 6. The contrast recovery coefficient (CRC) and its standard deviation values are plotted for three hot and cold lesions (S:B=4:1). (a) and (c) shows the two off-center hot lesions. (b) shows the central hot lesion, and (d) shows the cold lesion. Dashed, dash-dotted, dotted, and solid lines correspond to 0.5, 1, 2, and 3 mm lesions respectively. Collimated system CRC values were for four different scan times of t, 2t, 4t, and 8t, where t is the scan time for non-collimated system.

FIG. 7: Point-source spatial resolution when two flat detectors (4 mm pixels) are 100 cm apart. The plots show uncollimated (black), one collimator on each detector (magenta dashed), and one collimator on only the detector at 100 cm (red dotted). For one collimator, the resolution approaches that of no collimation at position 0 cm and that of collimation at 100 cm. Left: no acolinearity. Right: ¹⁸F acolinearity.

FIG. 8: Left: The Efficient FOV is the region inside the collimator' sacceptance angle. Right: The sensitivity is reduced uniformly by ˜4×(i.e., 0.25×uncollimated) in this region and drops monotonically outside. The region's diameter is twice the radial position at the plateau's edge. For A-PET, D=210 mm.

FIG. 9: Several crystals from the same segment. Left: The collimator is in position 0 for this segment. Right: Position 1. Table 1: Possible collimator positions (POS) for 4 segments (A-D). Eight POS are needed to sample all combinations of lines between all combinations of segments: AB, AC, AD, BC, BD, and CD. The collimator is rotated by 90° for most transformations. *Between POS 4 and 5 the collimator is switched or flipped, to reverse ‘handedness’. Each segment has two possible configurations as in FIG. 8. POS 1 measures line combination 01 for segment combination AD.

FIG. 10: Result of Geant4 septal penetration study in A-PET. The numbers of penetrating single photons are shown. The plots plateau by T=10 mm, except for α=0.

FIG. 11: Reconstructions of a hot-rod phantom in a warm background. Crystals sizes were modeled as 1 mm (top) and 2 mm (bottom). The rod diameters are 0.6, 0.8, 1.2, 1.6, 2.0, and 2.4 mm. Different levels of noise are shown for the reconstructions: 100k-2.56M coincidence pairs—in steps of factors of 4, just like the sensitivity reduction—and noiseless. In general, reconstructions with better resolution of the line pairs (top) show better image quality, especially for the smallest rods, than reconstructions with worse resolution but more counts (i.e., comparing along the diagonals).

FIG. 12: Contrast versus noise for a 0.5 mm centered lesion (4:1 contrast ratio for a 25 mm-diameter phantom. There are 3 curves: collimation (dotted), no collimation (solid line) and collimation with 4 times the counts (dashed), which has the same counts as uncollimated. A 0.5-mm lesion offset by 8 mm from the center yielded similar curves. In addition, 1 mm lesions, central and offset, also gave similar curves.

FIG. 13: Conceptual design of testing collimation with only a few collimator pieces in the transaxial direction. This early prototyping will allow for thorough experimental testing of sensitivity and resolution models for different collimator shapes and configurations.

FIG. 14: Likely aperture profile with acceptance angle α, channel C, thickness T, width w, and gap g.

FIG. 15: Sketch of transaxial collimator made from axial trapezoidal bars and two annular endplates. The placement of the bars will follow the pattern in Table D.1, where the segments A-D are labeled on the right endplate.

FIG. 16. Left: Conceptual drawing of collimator mounting mechanism. A support plate (black) will be mounted to the scanner. It will provide attachment and adjustment mechanisms for the annular plate (gray). There will be one set of plates per side. Right: Robotic stages will be used to translate and rotate the collimator, which will be attached using a cross support piece.

### DETAILED DESCRIPTION OF THE INVENTION

The invention relates to a collimation apparatus for use in biomedical imaging systems. Specifically, the invention relates to a collimation apparatus that blocks a portion of its crystal with a radiation blocking element.

In one embodiment, provided herein is a collimation apparatus comprising: a first ring comprising an array of crystals and a second ring comprising an array of radiation blocking elements, wherein said second ring is disposed inside said first ring, and wherein a portion of each crystal of said array of crystals is blocked by a radiation blocking element of said array of radiation blocking elements.

In another embodiment, provided herein is a PET scanner comprising a collimation apparatus, said collimation apparatus comprising: a first ring comprising an array of crystals and a second ring comprising an array of radiation blocking elements, wherein said second ring is disposed inside said first ring, and wherein a portion of each crystal of said array of crystals is blocked by a radiation blocking element of said array of radiation blocking elements.

The inventors of the instant application have developed a PET system with and without collimation. In the collimated system, half of each crystal pixel was covered with a tungsten septum, hence reducing the effective detector element size by a factor of two. In this study the inventors have evaluated and compared the effect of the resolution improvement of a small-animal PET system, which incorporates collimation, to an non-collimated PET system by measuring the Contrast Recovery Coefficient (CRC). The inventors have shown that the use of collimation surprisingly and unexpectedly improves the quantification and detection capabilities of a PET system.

In one aspect, the inventors' collimator simultaneously provides: (1) improved spatial resolution; and (2) improved sampling. The improved sampling may mean that different combinations of lines or response (LORs) can be measured. For example, if a crystal is splint into two conceptual parts and two crystals are needed to measure a line, then the number of lines for measurement increases from one to four (i.e., right-right, right-left, left-right, and left-left). In one embodiment, the sampling methods may include, but are not limited to, shifting the patient, shifting the collimator, rotating the collimator, or combinations thereof.

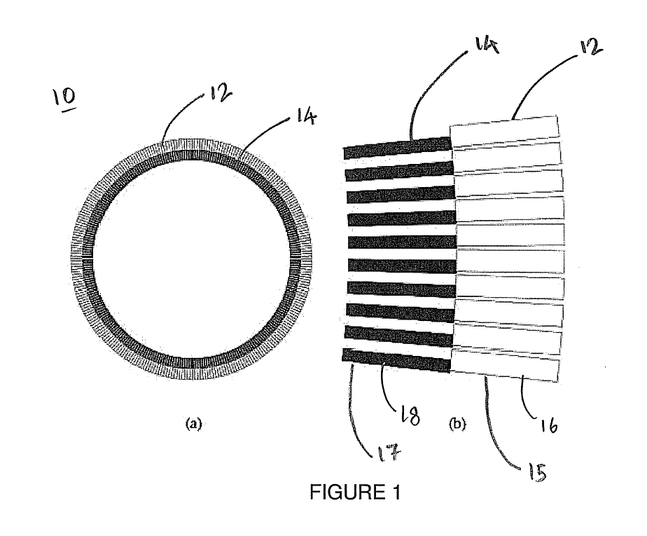

FIG. 1 shows an example of a collimation apparatus of the invention. As shown in FIG. 1(a), a collimation apparatus 10 may include a first ring 12 and a second ring 14. In one embodiment, second ring 14 may be disposed inside first ring 12. In some embodiments, first ring 12 may be operably linked to second ring 14 so as to provide collimation for imaging.

As shown in FIG. 1, first ring 12 may include an array of crystals 15 and second ring 14 may include an array of radiation blocking elements 17. Crystal array 15 may include a plurality of crystals 16. Any crystal suitable for imaging, known to one of skilled in the art, may be used. Imaging scanner crystals are well known in the art. Examples of crystals include, but are not limited to, a LaBr3 crystal, a lutetium Yttrium oxyorthosilicate (LYSO) crystal, and a lutetium oxyorthosilicate (LSO) crystal.

Array of radiation blocking elements 17 may include a plurality of radiation blocking elements 18. Any radiation blocking element suitable for collimation, known to one of skilled in the art, may be used. Radiation blocking elements for collimation are well known in the art. Examples of radiation blocking elements include, but are not limited to, lead, tungsten, and other lead-free radiation blocking elements.

In a particular embodiment, a portion of each crystal 16 may be blocked by radiation blocking element 18. In one embodiment, at least half of each crystal 16 may be blocked by radiation blocking element 18. In another embodiment, more than half of each crystal 16 may be blocked by radiation blocking element 18. In yet another embodiment, less than half of each crystal 16 may be blocked by radiation blocking element 18. Depending on a need, one of skilled in the art may select an area of blocking portion in crystal 16.

In another particular embodiment, as shown in FIG. 1(b), a portion of each crystal 16 may be blocked by radiation blocking element 18. In one exemplary embodiment, a portion of each crystal 16 may be blocked in transverse direction. In another exemplary embodiment, a portion of each crystal 16 may be blocked in axial direction. In yet another exemplary embodiment, a portion of each crystal 16 may be blocked in transverse-axial direction.

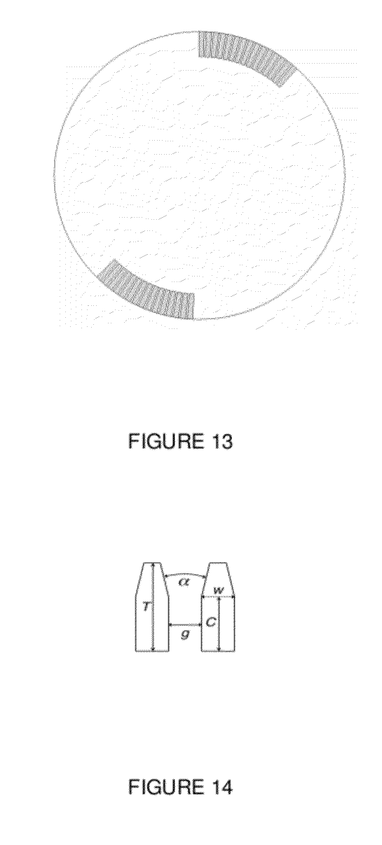

Depending on scanner type and need, any suitable size and dimensions of rings 12, 14 may be used. Also, depending on scanner type and need, any suitable size and dimensions of arrays 15, 17 may be used. In one embodiment, arrays 15, 17 are full circle arrays. In another embodiment, arrays 15, 17 are half circle arrays. In yet another embodiment, arrays 15, 17 are quarter circle arrays. In further embodiment, as shown in FIG. 13, arrays 15, 17 are less than quarter circle arrays.

Any suitable size and dimensions of crystals 16 and radiation blocking elements 18 may be used. In one example, crystal 16 dimension is 2×2×10 mm³ and radiation blocking element 18 dimension is 1×2×10 mm³, so that half of crystal 16 is covered by radiation blocking element 18. In another example, crystal 16 dimension is 4×4×30 mm³ and radiation blocking element 18 dimension is 2×4×30 mm³, so that half of crystal 16 is covered by radiation blocking element 18.

In one embodiment, collimation apparatus 10 comprises a mounting mechanism that facilitates mounting of apparatus 10 in a frame of a scanner. Collimation apparatus 10 may be used in any apparatus or scanner that requires collimation, for example, but are not limited to, a scanning or imaging apparatus. Examples of a scanning or imaging apparatus include, but are not limited to, a positron emission tomography (PET) scanner and a single photon emission computed tomography (SPECT) scanner.

In another embodiment provided herein is an imaging device or scanner (e.g., PET or SPECT scanner) a comprising a collimation apparatus 10, said collimation apparatus comprising: a first ring 12 comprising an array of crystals 15 and a second ring 14 comprising an array of radiation blocking elements 17, wherein said second ring 14 is disposed inside said first ring 12, and wherein a portion of each crystal 16 of said array of crystals 15 is blocked by a radiation blocking element 18 of said array of radiation blocking elements 17.

In another embodiment provided herein is a method of fabricating a collimation apparatus 10 comprising: providing a first ring 12 comprising an array of crystals 15; and providing a second ring 14 comprising an array of radiation blocking elements 17, said second ring 14 disposed inside said first ring 10, wherein a portion of each crystal 16 of said array of crystals 15 is blocked by a radiation blocking element 18 of said array of radiation blocking elements 17.

In another embodiment provided herein is a method for imaging a subject, the method comprising, providing a collimation apparatus 10, said collimation apparatus 10 comprising: a first ring 12 comprising an array of crystals 15 and a second ring 14 comprising an array of radiation blocking elements 17, wherein said second ring 14 is disposed inside said first ring 12, and wherein a portion of each crystal 16 of said array of crystals 15 is blocked by a radiation blocking element 18 of said array of radiation blocking elements 17.

In another embodiment provided herein is a method for improving a resolution of an image of a scanner, the method comprising, providing a collimation apparatus 10, said collimation apparatus 10 comprising: a first ring 12 comprising an array of crystals 15 and a second ring 14 comprising an array of radiation blocking elements 17, wherein said second ring 14 is disposed inside said first ring 12, and wherein a portion of each crystal 16 of said array of crystals 15 is blocked by a radiation blocking element 18 of said array of radiation blocking elements 17.

The term “subject,” as used herein, may refer to any mammal, including primates, such as monkeys and humans, horses, cows, cats, dogs, rabbits, and rodents such as rats and mice. In one embodiment, the subject is a human patient.

In one embodiment, a subject or a sample may be positioned in a scanner apparatus. Photons may be detected through collimation apparatus 10 to provide high resolution image data. Such data may be processed and analyzed through a processor (e.g., a computer) coupled to the scanner. In some embodiments, high resolution image data may displayed on a display unit coupled to the scanner.

The following examples are presented in order to more fully illustrate the preferred embodiments of the invention. They should in no way be construed, however, as limiting the broad scope of the invention.

### EXAMPLES

### Example 1

### Geant4 Evaluation of the Impact of Spatial Resolution Improvement on the Contrast Recovery Coefficient in a Small-Animal PET System with Collimation

Two limitations on the resolution of a reconstructed PET image are sampling and detector pixel size. Using collimation that partially blocks each crystal reduces the effective crystal size. Using different collimation positions increases sampling. In this study we determined the Contrast Recovery Coefficient (CRC) for a small-animal PET scanner with and without collimation in the transverse direction. We performed simulations of a single-slice small-animal PET system (205 mm diameter and 2×2×10 mm³ LYSO crystals). The septa forming the collimation were 1×2×10 mm³ tungsten pieces covering half of each crystal transaxially. Phantoms (25 mm diameter) with one cold and three hot lesions with diameter D (D=0.5, 1, 2, 3 mm) were simulated with two S:B ratios (4:1, 6:1). CRC=(S/B−1)/(T−1) where S and B are mean lesion (hot or cold) and background count densities, and T is true uptake ratio. CRC was measured from reconstructions to quantify the impact of the resolution improvement. Results show collimation improves mean CRC compared to non-collimated PET. For 1 mm hot lesions (4:1), scanned for the same duration, the collimated mean hot lesion CRC values (STD) were 0.44 (0.03) (center) and 0.24 (0.02) (off-center), where STD is the standard deviation of measured CRCs of an ensemble of images. Non-collimated results were 0.31 (0.01) and 0.18 (0.01), respectively. Although the total number of coincidences for the same scan time is fewer by about a factor of 4 in the collimated system, the measured mean CRC is higher. The efficiency loss in collimated PET manifests itself as worse STD in measured CRC and noisier images. When the collimated PET scan time is increased, the STD of measured CRCs improves and reaches that of non-collimated PET. In certain imaging scenarios, it may be possible to scan longer with a collimated PET system to make up for the efficiency loss. In conclusion, our study shows the use of collimation can improve the quantification and detection capabilities of a small-animal PET system.

### Methods

### A. Monte Carlo Simulation

Monte Carlo simulations were performed to model a small-animal PET system with and without collimation. The simulations were carried out in the framework of Gate. Gate is based on Geant4, a simulation toolkit that simulates particle interactions in bulk matter, and allows for complex geometrical models of emission tomography systems. In our simulations, the positron range and the acollinearity of the annihilation 511 keV gammas were simulated. The low energy physics processes modeling photoelectric effect, Compton and Rayleigh scattering were used.

For each event, the singles were constructed from energy depositions in each crystal and the positioning was done by finding the center of the energy depositions. The scintillation photon generation and optical photon tracking were not modeled. Then, for each event, the true coincidence events were formed by selecting the singles with the two highest energies. A minimum of 350 keV energy threshold was required for a single to be accepted.

1) Scanner Geometry: A single-slice small-animal PET system consisting of 280 LYSO crystals was simulated. The ring diameter was 205 mm. Each crystal had dimensions of 2×2×10 mm³ and was placed with a 2.3 mm pitch. The septa forming the collimator were made up of 1.15×2×10 mm³ tungsten blocks (See FIGS. 1(a) and 1(b)). Each crystal was fully blocked axially and only one half was blocked transaxially.

Each collimation configuration was formed from four sectors, each spanning quadrant covering 70 crystals. Within each sector, the septa configuration with respect to the crsytals was the same. Eight different collimation configurations were necessary and sufficient to sample all Lines of Response (LORs) inside the central field of view (FOV) of 30 mm diameter uniformly. We use a naming scheme such that (See Table I) L denotes that the left half (transaxially) of the crystal is blocked by a tungsten septum and R denotes that the right half of the crystals was blocked. For example in configuration number 2, the first two sector crystals are blocked by tungsten septa transaxially on the right (R), whereas the last two sector crystals are blocked on the left. In the collimated PET system, for a given crystal pair, there are four LORs connecting one half of the first crystal to one half of the other: LL, RL, LR, RR. In order to sample these four LORs for all crystal pairs uniformly in the central 30 mm diameter FOV, eight collimation configurations were necessary, sampling each LOR twice.

TABLE I
Eight collimation configurations were used in the simulations
to sample all LORs in the 30 mm central field of view.

| Collimator Configuration | Sector |
|---|---|
| Number | 1 2 3 4 |
| 1 | LLLL |
| 2 | RRLL |
| 3 | RLRL |
| 4 | LRRL |
| 5 | RLLR |
| 6 | LRLR |
| 7 | LLRR |
| 8 | RRRR |

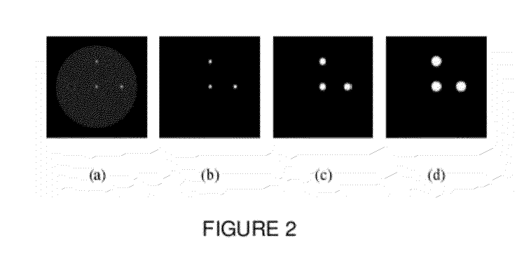

2). Simulated Source and Phantom: The simulated phantom was a disk with 25 mm diameter and 2 mm thickness and filled with water. The disk phantom had a uniform activity except for the lesion locations. There were three hot lesions and one cold lesion (See FIG. 2). The hot lesions were located at the center, 12 o'clock, and 3 o'clock, and the cold lesion was located at 9 o'clock. The cold lesion and the two off-center hot lesions were at a radial distance of 7.5 mm from the center of the phantom. Four different hot and cold lesion diameters (0.5, 1, 2, and 3 mm) and two hot lesion to warm background uptake ratios (4:1 and 6:1) were simulated

### B. Image Reconstruction and Analysis

As mentioned in Section II-A, Geant4 simulations generated true coincidence events formed from the singles. In the simulated PET ring, there were 280 crystals; yielding a total of 39060 LORs. For each true coincidence event, the corresponding LOR index was calculated from the two crystal indices to create binned projection data. In the collimated PET system, a separate binned projection was generated for each different collimation configuration.

Images were reconstructed with an FBP algorithm. The FBP reconstruction algorithm reads in the projection data, generates the sinogram, and reconstructs the image. In the case of the collimated system, the reconstruction algorithm has the collimation configuration information that tells the algorithm which half of each crystal is blocked by the septa. This information is used to generate a super-resolution sinogram with twice the number of crystals (280×2=560), from the true coincidence events that are based on 280 crystals. The images were reconstructed on a matrix of size 251×251. The voxel size of reconstructed images was 0.18×0.18 mm².

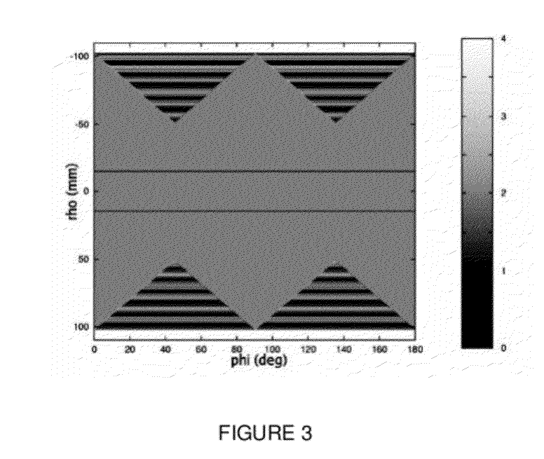

FIG. 3 shows the sampling map for a scan that uses the eight collimation configurations. The color code represents the number of times that each LOR is visited. The part of the map that corresponds to the central 30 mm diameter FOV is between the two black solid lines. In this region, when eight collimation configurations are used, each LOR is visited twice as shown by the uniformly gray region.

In the simulations, each tungsten septum had a height of 10 mm. This causes an efficiency non-uniformity inside the FOV. For a given angle φ, as the LOR distance from the center of the scanner, ρ, increases, the efficiency decreases since the LORs become more and more oblique with respect to the septa. Another factor contributing to the non-uniformity of the efficiency was the gap between the crystals. When not corrected, these non-uniformities caused artifacts in the reconstructed image. Efficiency non-uniformities were corrected by a normalization sinogram which was extracted from two sets of simulations of a uniform cylinder; one with 10 mm tall tungsten septa and another with a perfectly attenuating septa, which had no height (0 mm). The normalization sinogram was calculated by taking the bin by bin ratio of the sinograms from the two aforementioned simulations. The correction to the sinograms was also applied bin by bin.

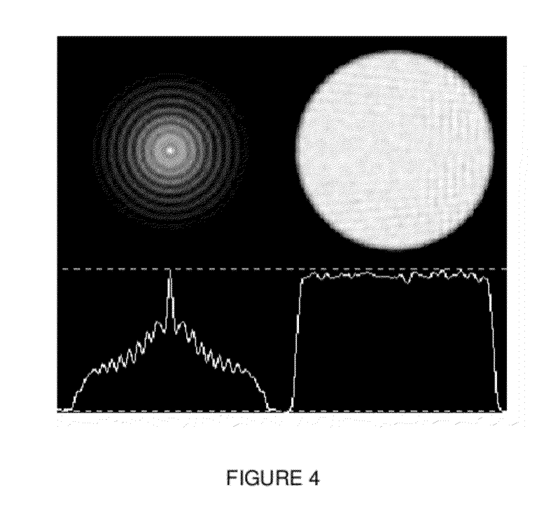

In FIG. 4, the reconstructed images of a uniform cylinder phantom scanned with the collimated PET system are shown. The left column shows the image (top) and its profile through center (bottom) when the reconstruction is done without the normalization correction. The decrease in efficiency as the radial distance from the center increases is apparent in the profile. The right column shows the reconstructed image (top) and its profile through the center (bottom) when the normalization correction is applied on the sinogram before the reconstruction.

The CRC values for the lesions were calculated as

CRC=(S/B−1)/(T−1),

where S and B are the mean lesion (hot or cold) and background counts as measured from a circular region of interest (ROI), respectively and T is the true activity-uptake ratio. In the calculation of mean counts, only those voxels that are fully inside the ROI were used. For the hot and cold lesions the ROI was drawn with the same diameter as the lesion. The ROIs to measure the mean background counts were drawn as circles with 4 mm diameter, 7.5 mm away from the phantom center in 6 o'clock direction (See FIG. 2).

The standard deviations (STD) of the calculated CRCs were taken as the STD of the CRCs for the ensemble of reconstructed images from independent simulations. The number of images in the ensembles were 10, 20, 40, and 80 for scan times of 8t, 4t, 2t, and t, respectively.

### Results

The reconstructed images are shown for both non-collimated and collimated PET systems in FIG. 5. First, second, third and fourth rows correspond to 0.5, 1, 2, and 3 mm lesions, respectively. The first column shows the reconstructed images for the non-collimated system with scan time t. The second column is for the collimated PET system with same scan time t. The third, fourth, and fifth columns show reconstructed images by the collimated PET system with scan times of 2t, 4t, and 8t, respectively.

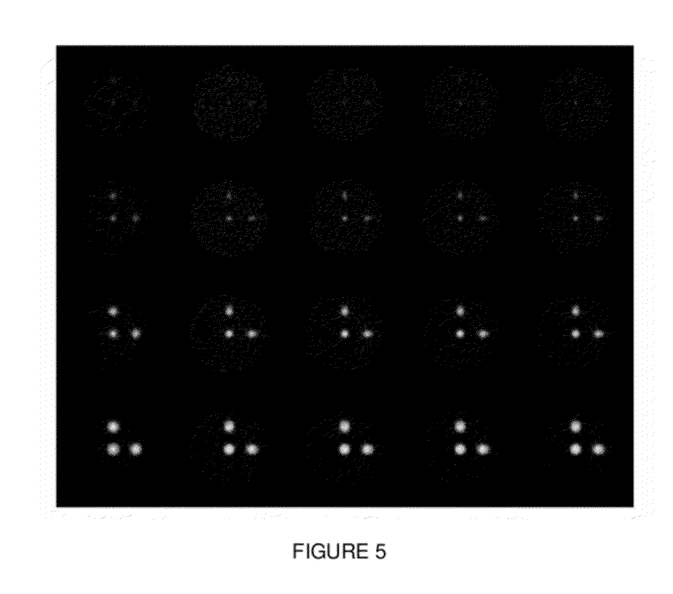

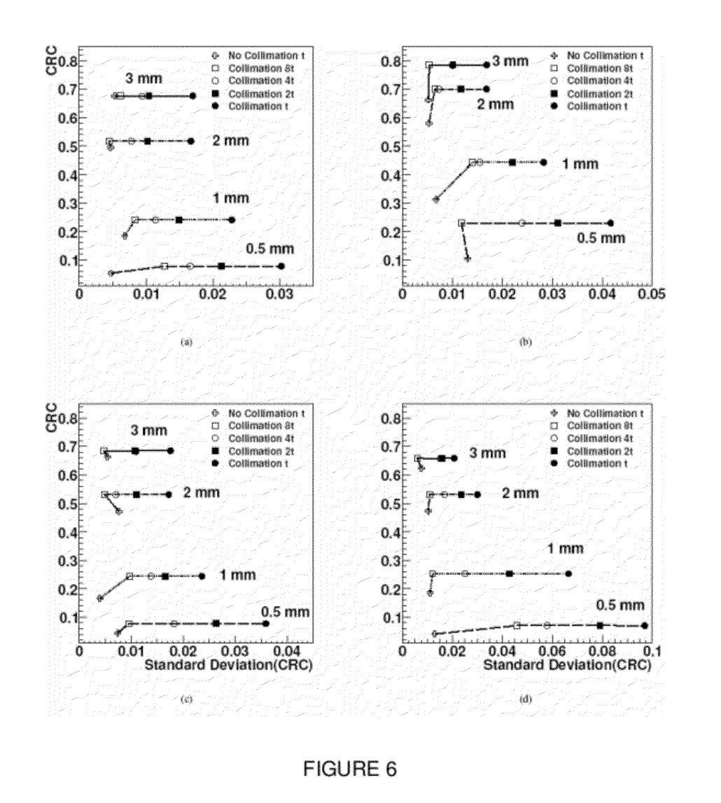

In Tables II and III, the measured CRC and STD values for the central and side hot lesions, and the cold lesion for 4:1 and 6:1 true uptake ratios are tabulated. In FIG. 6, the measured mean CRC values for hot and cold lesions of varying sizes with 4:1 true uptake ratio are plotted as a function of their STD values. Dashed, dash-dotted, dotted and solid lines correspond to 0.5, 1, 2, 3 mm lesions, respectively. For example, for the phantom with 1 mm lesions (4:1 uptake ratio), the collimated system with scan time t resulted in reconstructed images with mean CRC (STD) values of 0.44 (0.03) for the central hot lesion and 0.24 (0.02) for the off-center hot lesion. The corresponding mean CRC (STD) values for the non-collimated system were 0.31 (0.01) and 0.18 (0.01), respectively. For the same phantom, cold lesion mean CRC (STD) values were measured as 0.25 (0.07) and 0.19 (0.01) for the collimated and the non-collimated systems, respectively.

When the collimated PET is given the advantage of longer scan times, the measured standard deviation of the CRC values improved and reached that of the non-collimated system (See FIG. 5 and Tables II and III). Similar results were obtained with 6:1 uptake ratio simulations.

TABLE II
Measured central hot lesion (4:1 true uptake ratio) CRC and STD (CRC) values for non-collimated (NC)
with scan time and collimated (C) system with varying scan times of T, 2T, 4T and 8T are shown.

| | CRC (STD) | | | | |
|---|---|---|---|---|---|
| LESION SIZE | NC t | C 8t | C 4t | C 2t | C t |
| Central Hot 0.5 mm | 0.229 (0.031) | 0.229 (0.042) | 0.229 (0.024) | 0.229 (0.012) | 0.229 (0.031) |
| Central Hot 1 mm | 0.313 (0.007) | 0.443 (0.022) | 0.443 (0.015) | 0.443 (0.022) | 0.443 (0.028) |
| Central Hot 2 mm | 0.580 (0.005) | 0.700 (0.006) | 0.700 (0.006) | 0.700 (0.012) | 0.700 (0.017) |
| Central Hot 3 mm | 0.785 (0.005) | 0.785 (0.010) | 0.783 (0.010) | 0.785 (0.010) | 0.785 (0.010) |
| Side Hot 0.5 mm | 0.054 (0.005) | 0.078 (0.030) | 0.078 (0.017) | 0.078 (0.021) | 0.078 (0.030) |
| Side Hot 1 mm | 0.185 (0.007) | 0.241 (0.008) | 0.241 (0.011) | 0.241 (0.015) | 0.241 (0.023) |
| Side Hot 2 mm | 0.517 (0.008) | 0.517 (0.004) | 0.517 (0.008) | 0.517 (0.004) | 0.517 (0.010) |
| Side Hot 3 mm | 0.675 (0.009) | 0.676 (0.006) | 0.675 (0.009) | 0.676 (0.010) | 0.676 (0.017) |
| Cold 0.5 mm | 0.041 (0.013) | 0.071 (0.046) | 0.071 (0.058) | 0.071 (0.079) | 0.071 (0.097) |
| Cold 1 mm | 0.186 (0.011) | 0.253 (0.012) | 0.253 (0.012) | 0.253 (0.043) | 0.253 (0.067) |
| Cold 2 mm | 0.531 (0.017) | 0.531 (0.023) | 0.531 (0.017) | 0.531 (0.023) | 0.531 (0.029) |
| Cold 3 mm | 0.657 (0.015) | 0.658 (0.016) | 0.657 (0.015) | 0.658 (0.016) | 0.658 (0.021) |

TABLE III
Measured central hot lesion (6:1 true uptake ratio) CRC and STD (CRC)
values for non-collimated (NC) with scan time T and collimated (C)
system with varying scan times of T, 2T, 4T and 8T are shown.

| | CRC (STD) | | | | |
|---|---|---|---|---|---|
| LESION SIZE | NC t | C 8t | C 4t | C 2t | C t |
| Central Hot 0.5 mm | 0.220 (0.016) | 0.220 (0.011) | 0.220 (0.016) | 0.220 (0.011) | 0.220 (0.033) |
| Central Hot 1 mm | 0.442 (0.016) | 0.02 (0.008) | 0.02 (0.012) | 0.02 (0.016) | 0.442 (0.016) |
| Central Hot 2 mm | 0.701 (0.009) | 0.701 (0.007) | 0.701 (0.009) | 0.701 (0.013) | 0.701 (0.020) |
| Central Hot 3 mm | 0.663 (0.009) | 0.784 (0.008) | 0.784 (0.012) | 0.784 (0.016) | 0.784 (0.016) |
| Side Hot 0.5 mm | 0.079 (0.024) | 0.079 (0.006) | 0.079 (0.015) | 0.079 (0.018) | 0.079 (0.024) |
| Side Hot 1 mm | 0.181 (0.005) | 0.243 (0.009) | 0.243 (0.012) | 0.243 (0.016) | 0.243 (0.016) |
| Side Hot 2 mm | 0.492 (0.007) | 0.519 (0.003) | 0.519 (0.006) | 0.519 (0.003) | 0.519 (0.015) |
| Side Hot 3 mm | 0.677 (0.009) | 0.676 (0.007) | 0.676 (0.010) | 0.676 (0.014) | 0.676 (0.018) |
| Cold 0.5 mm | 0.069 (0.087) | 0.069 (0.031) | 0.069 (0.049) | 0.069 (0.087) | 0.069 (0.127) |
| Cold 1 mm | 0.241 (0.048) | 0.241 (0.032) | 0.241 (0.048) | 0.241 (0.073) | 0.241 (0.093) |
| Cold 2 mm | 0.523 (0.021) | 0.523 (0.013) | 0.523 (0.013) | 0.523 (0.013) | 0.523 (0.042) |
| Cold 3 mm | 0.586 (0.011) | 0.647 (0.007) | 0.647 (0.009) | 0.647 (0.007) | 0.647 (0.026) |

The use of collimation in a PET system results in a loss in the system efficiency. When one half of each crystal was covered by a tungsten septum, the loss in the number of acquired coincidences (efficiency) is about a factor of four, whereas the system resolution (as measured with a point source scan) improves by about a factor of two since the effective detector element size is reduced in half.

The resolution improvement with the collimated PET system was observed also in the reconstructed images of phantoms with different lesion sizes. The loss in the system efficiency is apparent in noisier reconstructed images with collimated PET compared to the non-collimated as seen in FIG. 5.

Use of the collimation also improves the sampling. We simulated only a single PET ring and half of each crystal was blocked by septa transaxially (i.e., the septa were covering the whole crystal half axially). Therefore the image reconstructions were carried out only in the transverse plane. For this system geometry, the number of LORs in the collimated PET system is about four times the number of the non-collimated system.

Results from the Geant4 simulations showed that when the phantoms with lesions in a warm background are scanned with the collimated PET system, higher mean CRC values for both hot and cold lesions were obtained compared to the scans with the non-collimated system. The mean CRC values for the side hot lesions were smaller than the central hot lesion. This is probably due to the radial blurring seen for the off-centered lesions in the reconstructed images. The measured mean CRC values of cold lesions were similar to that of off-center hot lesions.

The simulation results also show that higher mean CRC values are measured for larger lesions. For example for the collimated PET system, the measured CRCs (STD) for 2 and 3 mm central hot lesion phantoms are 0.70 (0.02) and 0.79 (0.02) respectively. The corresponding measured CRC (STD) values for the non-collimated PET system are 0.58 (0.01) and 0.66 (0.01). This is due to the fact that the system resolution becomes smaller compared to the lesion size.

In addition, when the collimated PET is given the advantage of longer scanning times, the noise in the reconstructed images improved and reached to the noise levels similar to that of non-collimated system. For example, for the 1mm lesion phantom with 4:1 uptake ratio, the STD for the central lesion improves from 0.03 for the scan time t to 0.01 for a scan time of 8t. Similarly, for the cold lesion STD improved from 0.067 to 0.01 when the scan time was t and 8t respectively.

In conclusion, the simulation results have shown that using collimation in PET improves the CRC compared to the non-collimated PET and can improve the quantification and detection capabilities of a small-animal PET system.

### Example 2

### Collimation for PET Systems

The ability of positron emission tomography (PET) to detect and quantify small lesions is limited mostly by a combination of the spatial resolution of the detected coincidence pairs and the number of pairs available for reconstruction (i.e., the sensitivity), with some contaminating factors such as scatter and randoms. There are several factors impacting the resolution of the coincidence pairs, including acolinearity, positron range, crystal size, and inter-crystal scatter. Decreasing the face size of the crystals improves resolution, but increases the impact of inter-crystal scatter, diminishing the improvement. The impact of depth of interaction also increases because the probability of exiting the primary (i.e., first) crystal increases. In addition, the fabrication cost can also increase dramatically for finer crystals. On the other hand, there are mechanical techniques for improving the reconstructed resolution, such as wobbling to improve sampling, but wobbling does not improve the spatial resolution of the photons in detector space. Here we use a moving collimator, trading sensitivity for improved detector-space resolution of each coincidence pair, gaining improved sampling in the process. This combination of improved detector-space resolution and improved sampling can improve reconstructed resolution and quantification, even when compared to wobbling as an alternative.

Collimation can be used for PET applications to improve spatial resolution and quantification despite the loss of sensitivity. There are cases in PET (e.g., brain imaging) where the limitation in the reconstructed image is dominated by the scanner's resolution, not the sensitivity. Trading sensitivity for improved spatial information can result in reconstructions with both better resolution and better quantitative information for many small-animal and human applications, including breast, prostate, and brain imaging and radiotherapy planning. Collimation can be used and moved during the scan to narrow the widths of the lines of response (LORs) of the scanner and improve the spatial sampling, respectively. Although collimation reduces sensitivity, the detected location of one or both observed photons of the pair has improved spatial resolution. In particular, that resolution can be a fraction of the crystal size.

The collimator can limit the observed photon pairs to the effective area of the collimator; the crystal size will be less important. The collimator can be removable so the scanner could be used with or without it; one consequence is that the collimator could be an upgrade to existing systems or used only when expected to be advantageous. The challenge for PET is to develop a collimator that effectively shields the crystals to obtain higher resolution for 511 keV photons and to efficiently measure the increased number of sampled LORs.

Collimation's feasibility can be evaluated using research scanners for both the small-animal (A-PET) and human (La-PET) scales. Fundamental models of effective sensitivity and point-spread function (PSF) for both scales, limited to the transverse direction, can be developed. These models can be compared with experimental data from a limited testing apparatus on both scanners. A full collimator can be built for A-PET for experimental evaluations and to refine the simulations. A full collimation can be evaluated on La-PET, but with only simulated data.

In particular, one of skilled in the art can (i) develop detailed analytic models for the sensitivity and PSF as a function of collimator parameters and crystal/detector properties; (ii) test those models using Geant4 simulations of the scanners; and (iii) design and build for both scanners a limited experimental apparatus to test the models for different transaxial collimator configurations; (iii) design the shielding and mechanical systems for an experimental prototype on A-PET; and (iv) mechanically and electronically integrate the system; (v) modify existing list-mode reconstruction programs to utilize the resolution-enhanced emission data; (vi) incorporate models of sensitivity and PSF with collimation; and (vii) incorporate corrections for attenuation and scatter; (viii) determine the sensitivity and detector-space resolution for the full collimator systems; (ix) determine the reconstructed resolution; and (x) determine contrast-vs-noise curves for different lesion contrasts, sizes, and locations as a means of testing quantification. One of skilled in the art can also compare experimental and simulated results (a) with and without collimation,modeling the PSF and sensitivity in both cases, and (b) as a function of number of acquired counts.

The innovation in this project lies in the application of collimation to PET in a novel way for simultaneously improving spatial resolution and sampling. In the early 1980's, Z. H. Cho used 25 mm-diameter NaI crystals each fitted with a collimator that had an opening of about 5 mm×10 mm, whereas we use crystals that have 2 mm edges (A-PET) and 4 mm edges (La-PET), with apertures half that size. Thus, the aperture's penetration and acceptance angle will be much more important on this scale.

The invention also relates to methods for increasing sampling using this “insertable/removable” device. Improved sampling can be achieved by (i) rotating the collimator; (ii) shifting the collimator; or (iii) shifting the patient. In the clinic, the third option may be the most practical since the collimator could be inserted on a fixed mounting mechanism, making it very reproducible.

The use of collimation also differs from other current attempts at improvements such as using finer crystals and high-resolution inserts. This is also a relatively inexpensive way of achieving higher resolution with minimal physical changes to the scanner and no electronic changes.

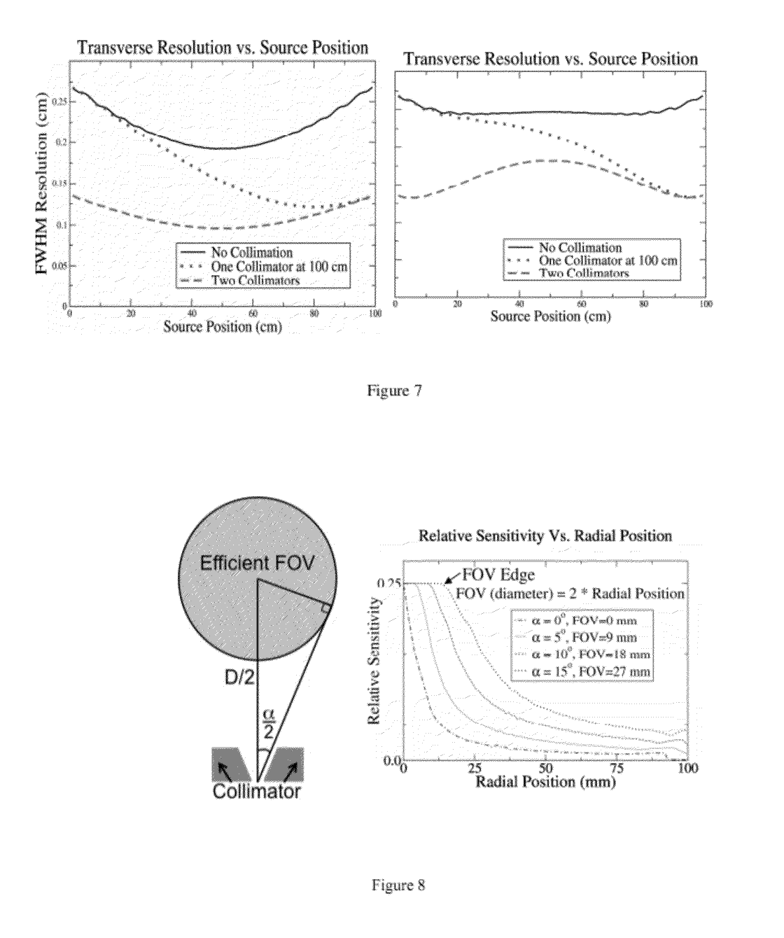

Lastly, the collimation of the invention further relates to use transverse-only, axial-only, focused, or partial-ring geometries. In particular, the partial-ring geometry may combine the benefit of improved resolution and sampling with the improved sensitivity of no collimation for some specific applications, since most of the gain is near the collimator (FIG. 7).

Brief Description of System with Collimation

Collimation can be situated just inside the PET crystal ring. The small-animal PET system, A-PET, has a circular LYSO crystal ring (2.0 mm×2.0 mm×10 mm crystals) with a 21-cm diameter and reconstructed resolution of ˜1.9 mm. The whole-body time-of-flight system, La-PET, has a LaBr₃ crystal ring (4.0 mm×4.0 mm×30 mm crystals) that is 24-sided with a 93 cm diameter and reconstructed resolution of ˜5.6 mm. Both systems are available to us in our research labs. Both have a transmission source. Both systems may be used for characterization because they expand the range of our model testing. Resolution and quantification of a full prototype collimator may be evaluated on only A-PET to limit this proposal's scope; a similar evaluation may be conducted for La-PET, but using simulated data.

One aspect of the invention is to have the collimator cover half of each crystal in the transverse direction; collimating axially and varying the crystal coverage. The transverse-only collimation may provide improved imaging characteristics for many PET scans, including brain, breast, and prostate. Although collimation decreases sensitivity, the resolution of detected LORs is improved. Further, when we expose only half of the crystal at a time, each crystal has two responses and each crystal pair has 4 times the responses. Thus, sampling can be dramatically improved.

### Resolution and Sensitivity

In the limiting case of an ideal collimator that is perfectly attenuating and has zero thickness, the sensitivity may be reduced by 4× because half of all photons can be absorbed by the collimator, but the resolution can be improved by 2× in the two transverse directions, giving a 4× improvement in volume resolution. This sensitivity reduction is true for both 2D and 3D modes since half the crystal surface area is inactive. For a realistic collimator, some fraction of photons may penetrate the material, increasing sensitivity and worsening resolution. The amount of penetration depends on the collimator thickness and acceptance angle (FIG. 14) since a larger acceptance angle increases penetration, but also increases the field of view (FOV).

### Efficient Field of View

The Efficient FOV (FIG. 8) is where sensitivity drops uniformly by ˜4×. This FOV's diameter is D sin(α/2), where α is the collimator's acceptance angle and D is the scanner's diameter. Outside this region, sensitivity drops monotonically with radial position. It is likely for mouse imaging that we can find a reasonable balance between penetration and Efficient FOV (˜15 mm). For clinical imaging, the Efficient FOV may probably be smaller than the patient (˜10-20 cm depending on how much penetration is allowed). This will be useful if the region of interest (e.g., breast, prostate) is positioned within the Efficient FOV. For larger organs, there may be partially truncation, but this can be overcome by combining with uncollimated data to mitigate artifacts outside the Efficient FOV.

### Sampling

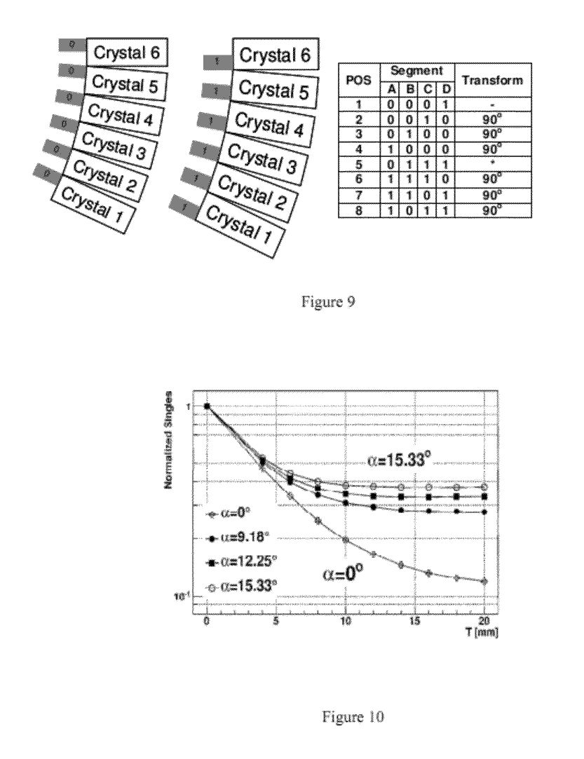

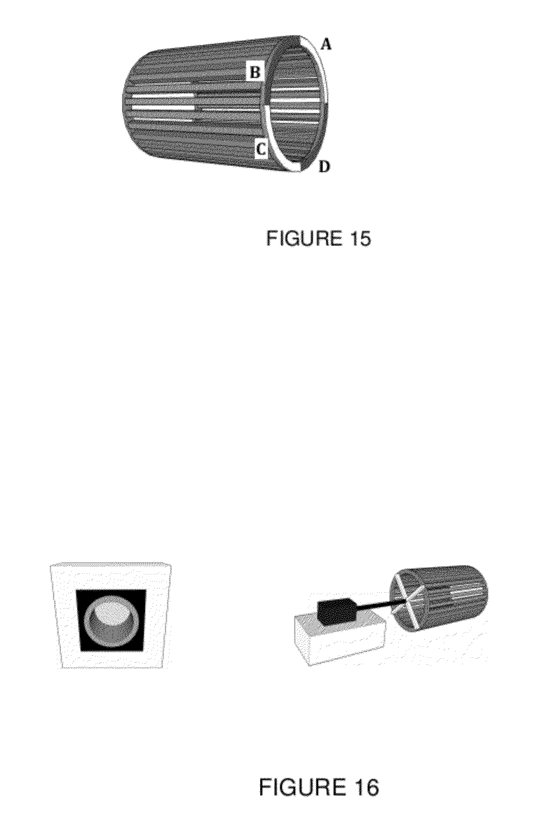

The scanner can be pardoned into mazimuthal segments (FIG. 15 with 4 segments labeled A-D). All crystals within a segment expose the same portion of the crystal (e.g., left half) at the same time (FIG. 9). All combinations of exposures for each segment with every other segment can be measured to have a complete data set. The field of view (FOV) that measures all line combinations, the Enhanced FOV (EFOV), depends on m; the diameter of the EFOV is 2r_{FOV}=Dcos(lm), for m>2, where D is the ring diameter. In our design, one can attempt to match m to the Efficient FOV, which depends on α. Reconstruction of regions outside of Dcos(lm) can still be artifact free but cannot have the sampling advantage of inside the EFOV.

One needs 8 acquisitions to measure all combinations of lines uniformly for m=4. Table 1 is an example configuration using rotations and a flip. We can design a collimator that measures different combinations for each axial slice and then to push the patient through the scanner one slice at a time—a design probably more appropriate for clinical imaging.

### Studies on Collimation

### Geant4 Studies of Septal Penetration of 511 keV Photons in A-PET

We have performed studies of septal penetration to understand the collimator's thickness (T) and acceptance angle (α) needed to restrict 511 keV photons from passing through the septa (see FIG. 14. In this study w=g=1 mm;C=0). As α decreases, the amount of attenuating material increases near the edge, but the FOV is restricted. FIG. 10 plots the normalized number of simulated single photons penetrating the tungsten (19.4 g/cm³) collimatorvs. T and for several values of α. The plot plateaus at T=˜8-10 mm, except for α=0, which is a channel (equivalently C=T), often used to reduce edge penetration. This indicates there is no advantage in making collimation thicker than 10 mm because of edge penetration. A-PET has sufficient room to accommodate 10 mm-thick collimation.

Geant4 Studies of Resolution with Collimation

We used Geant4 to make a measurement of the spatial resolution with collimation using a model of A-PET with a single axial ring of 280 LYSO crystals (2.0×2.0×10 mm). We also developed a model for collimation that used 1.0×2.0×10 mm rectangular septa, covering the full length of the crystal axially and half transaxially. Without collimation, the full width at half maximum (FWHM) resolution is 0.99 mm with a relative sensitivity of 1.0. For tungsten collimation, the resolution is 0.59 mm and the relative sensitivity is 0.27. The results show that linear resolution can be improved by ˜2× in the two transverse directions (˜4× volume-resolution improvement) for a sensitivity loss by ˜4×, for these transverse-only septa.

### Resolution vs Sensitivity

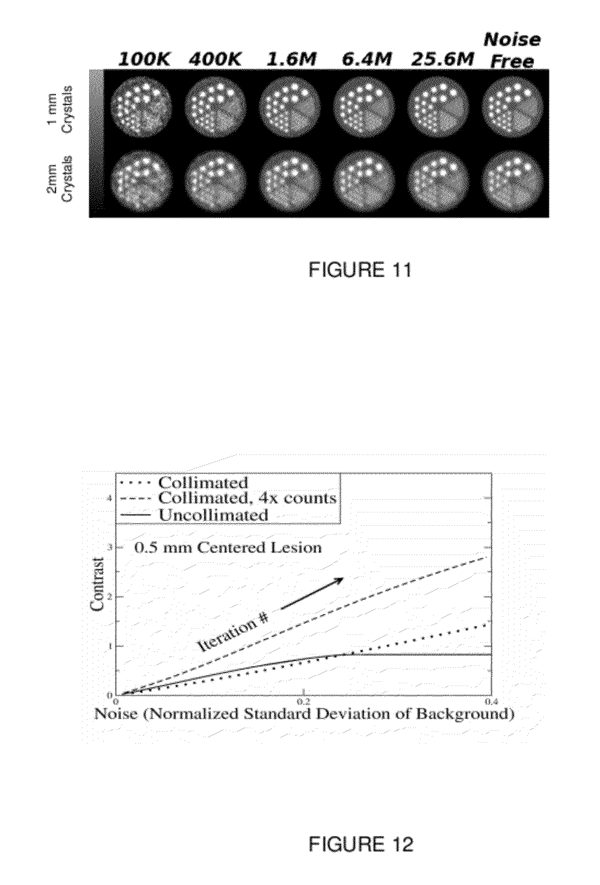

We have conducted studies to determine if there is potential gain in image resolution and overall image quality if one improves the resolution of the coincidence pairs, but reduces their sensitivity using a single axial slice of the A-PET scanner using the same iterative reconstruction program (20 iterations; no post-processing; 0.25 mm wide voxels). The phantom was a 25 mm-diameter warm background with six sectors of hot-rods (4:1 signal-to-background ratio). The difference was the crystal size: 2 mm vs. 1 mm, which is equivalent to collimation of 2 mm crystals. We performed reconstructions for noiseless and different noise levels in the projection data, varying by factors of 4, which is the sensitivity loss using transverse collimation. FIG. 11 shows the results. For realistic count densities, these preliminary data indicate it is worthwhile to give up counts to gain resolution on those photon pairs, especially for small structures or if those counts may be recouped with a longer scan. A phantom like in FIG. 11 can be used in evaluations of resolution vs. sensitivity.

### Contrast vs Noise

A uniform phantom 25 mm in diameter with two configurations for lesions (centered and 8 mm off-center, both with contrast of 4:1) were simulated (100 noise realizations) for three situations based on the 21 cm A-PET scanner: (i) collimation (100 k counts); (ii) no collimation (400 k counts); and (iii) collimation with 4× counts (400 k). That is, (i) and (ii) had the same scan time and (iii) had 4× the scan time. There were two lesion sizes: 0.5 and 1.0 mm in diameter. FIG. 12 shows the results for the 0.5-mm centered lesions. The other combinations give similar results with the uncollimated having contrast between (i) and (ii) for low noise and then plateauing. As the iteration # increases, which increases background noise, the collimated results, even with 4× fewer counts, start to surpass the uncollimated results since the collimator has higher potential for contrast recovery of small lesions. When the counts are the same, collimation always shows improved contrast at the same noise level. Many studies at the animal-imaging facility are not count limited, either through additional scan time or high-count rate. Figures like in FIG. 12 can be used in evaluations of contrast vs. noise.

Characterize Scanner Performance with and without Collimation

We have previously been able to develop successful models for resolution and sensitivity in SPECT, including the penetration and detector-response components. We can start with models of PET crystal and detector response (i.e., the PSF without collimation); these models are part of ongoing work for another project. We can apply similar methods as in our SPECT work to develop analytic models that accurately estimate the amount of collimator penetration and its spread (i.e., the collimator response). These penetration models can be challenging since penetration is much more extensive at 511 keV than at SPECT energies. The advantage of having these models, which will be convolved to estimate the total response with collimation, is that they will aid design by more directly showing how the relevant parameters (collimator thickness, acceptance angle, spacing, etc. . . . ) interact. In contrast, design without this guidance would rely on a more brute-force approach of simulating many configurations and determining the best; in this case, one can find phenomenological models from these simulated data.

The analytic and Geant4 models of sensitivity and resolution can be validated with collimation since they may impact the design of the experimental prototype for A-PET, feed into the reconstruction software, and affect the evaluations for La-PET, which may be conducted in simulation. We can design and build experimental systems for both A-PET and La-PET with a limited number of collimator pieces, much like those shown in FIG. 13; FIG. 14 shows profiles of individual septal pieces. There are several reasons for using only a small number of collimator pieces rather than an entire ring: (i) the fixtures can be designed to be more flexible, allowing pieces with different sizes, shapes, and spacings; (ii) the system can be used in either singles (i.e., having collimation on only a small, contiguous portion of the scanner) or coincidence mode (i.e., two opposed sections with collimation); and (iii) lower cost of construction because only a small number of pieces are needed, and looser tolerances since there is no risk of cumulative error, such as in the case of fabricating many pieces that must form a circle. Septa with different materials, thicknesses, widths, gaps, and acceptance angles (FIG. 14) can be tested on both A-PET and La-PET.

### Possible Fabrication Technique for A-PET Collimator

Many identical trapezoidal bars (with angle α/2 on each side) out of tungsten can be fabricated. These pieces can run the axial length of the scanner and can be held together with two endplates (FIG. 15). Since A-PET crystals are aligned slice-to-slice, all axial slices can have the same collimator configuration. We can machine the endplates with grooves to hold the bars with the correct orientation and position given by the pattern in Table 1 for increasing the sampling. In addition, the bars can be tapped to accept a screw on each end. The screws can go through the endplate into the bars to secure them. Tapping the tungsten may require drilling it out and inserting an aluminum plug. Other mechanisms for securing the assembly can also be considered in consultation with our local machine shop. Other possibilities may include the use of epoxy to hold the bars in the groove or to use two-piece retaining rings that would fit over notches at the ends of the bars.

### Software Design Tools

Geant4 can be used to provide detailed models of the system response with various collimator configurations. Once validated with analytic and experimental results, these sensitivity and resolution models can be incorporated into a specialized program for generating simulated projections, including ensembles, which can be input to the reconstruction program.

Integrate Collimation with Scanner

After the design and fabrication of the collimation for A-PET, it can be mechanically integrated with the PET system, including a mechanism for mounting the collimator directly to the PET system (FIG. 16) and providing for rotation and translation (for moving it into and out of the FOV). Our preliminary design can mount one square plate (black in FIG. 16, left) with a bore on each side of the scanner (i.e., two square plates). An annular plate, probably with a ball-bearing race to ease rotation, can be mounted to each square plate.

Attaching the stages to the collimation can be an important part of the mechanical integration. We have experience with similar integration for our helical pinhole SPECT system, where stages were aligned with a clinical SPECT scanner. For this project, we can use the same stages to reduce cost. We can attach a threaded cross support to one side of the collimator and mount to the robotic stages using a rod (FIG. 16, right).

LabView can be used to coordinate the collimator's motion with the PET data stream. The PET system may acquire data in list mode, embedding flags in the data stream using the gating port to indicate when the collimator has moved. The gating port can be utilized with a direct connection through LabView. If the direct connection fails, we can design and build a small electronic interface, similar to what we have previously done for synchronizing the stage to the clinical SPECT system for helical pinhole SPECT.

### Calibration

As part of the integration, we can determine the orientation and position of the collimation, which can be necessary for detailed studies of resolution with point sources and also for reconstruction. We can put a point source on a rod attached to a linear stage near the center of the scanner. We can acquire projection data at different positions for the point source. We can also shift and rotate the collimator in small steps relative to the crystal size. In particular, we can look at the pattern of singles and coincidences for certain crystals. We can exploit the boundaries of segments to determine (and adjust) the rotational orientation. At these boundaries, there are often either two adjacent blocked half crystals or two adjacent open half crystals; elsewhere half crystals alternate between exposed and blocked.

### Develop Iterative Reconstruction

### Overview

To fully utilize the improved spatial information from collimation requires statistical iterative reconstruction with an accurate data model. Emission data can be mathematically described by the system of linear equations [118]; Mᵢ( [symbol] )=bᵢ+Σⱼ₌₁^{nvox}Pᵢⱼλⱼ, where Mᵢ is the expected number of coincidence pairs detected at LOR i (LORᵢ),λⱼ is the expected number of pairs emitted from image location j, Pᵢⱼ is the probability that a pair emitted from image location j will be detected at LORᵢ, and bᵢ is the expected number of background pairs detected at LORᵢ from processes not modeled in Pᵢⱼ, such as scatter and random events.

Matrix P includes the geometric and detector efficiency components, the resolution component defining the spread of a given measurement, and the attenuation factor. The resolution component can be obtained from the validated PSF models and can be verified for each collimator position. Proper, accurate and efficient handling of the resolution component can represent the most challenging part of the reconstruction approaches within this project. The above scheme can be used to employ resolution recovery without collimation; in this case, the PSF is normalized to unity; with collimation, the PSF is normalized to the collimator's sensitivity.

### Algorithm

We have experience with algorithms maximizing the likelihood of emission data and will re-use existing list-mode algorithms for A-PET and La-PET reconstruction, making modifications to account for the collimation. That is, the algorithm needs to consider the correct PSF for the collimator at the time of each photon's acquisition. In addition, the algorithm will handle truncation and also allow for combining truncated and untruncated data in reconstruction.

### Data Corrections

Typical emission data are contaminated by several physical factors, which can be characterized by the way they are treated as multiplicative and additive. We can use existing methods already in the reconstruction programs for multiplicative corrections that include attenuation correction, normalization, and the sensitivity matrix. The two additive corrections we will include are random coincidences and scatter. We will re-use the method already implemented for random-coincidence correction: acquiring delayed coincidences followed by strong spatial smoothing. Based on our experience from other projects we will modify and apply the existing single-scatter simulation algorithm to calculate the scattered events in this project, accounting for collimation's impact on scattered events and for scatter within the collimator.

### Evaluating the System

A-PET collimator can be experimentally evaluated and similar simulation studies can be conducted for La-PET. These evaluations in simulation may consider the experimentally validated models for PSF and sensitivity for La-PET and incorporate any findings from the experimental evaluation of A-PET. For both scanners we may measure resolution and sensitivity comparing results with and without collimation. NEMA-defined techniques may be used to measure spatial resolution, sensitivity, scatter fraction, and count-rate performance. In addition to the NEMA measurements, point-source data can be analyzed to more fully investigate the FWHM and other quantitative measures of resolution. Further, reconstructions of rod and hollow-sphere phantoms can be analyzed to determine resolution and contrast recovery in reconstruction.

Additional PSF and Sensitivity Measurement with Point Source

The PSF can be measured on A-PET by stepping a point source with computer-controlled stages already in our lab through a series of positions for different locations in the scanner. The steps can be small relative to the expected resolution and the direction can be perpendicular to the LOR under investigation. The resolution measurement can be determined as the number of counts per unit time versus the position of the source. The shape of the resolution response (e.g., FWHM, FWTM) and the count rate (i.e., sensitivity) can be compared to the case of no collimation. The measurements can be made as a function of position in the FOV.

The experimental and simulated results for PSF and sensitivity can be compared with theoretical predictions taking the septal penetration into account.

Evaluation of Reconstruction Resolution with Rod Phantoms

Hot- and cold-rod phantoms can be used to measure transaxial resolution in reconstruction. Experiments can be performed with and without the resolution-enhancing collimation. Further, background can be added to hot-rod phantoms by acquiring a uniform cylinder (i.e., no hot-rod insert) in addition to the data set with the insert; the data sets can be added in post-acquisition processing. When imaging cold-rod phantoms, the cold rods are voids in the warm background, making them harder to resolve than hot rods. We can reconstruct as a function of number of counts, as in FIG. 11, and make both a visual and quantitative assessment using profiles through the rods.

Evaluation of Lesion-Contrast Estimation with Hollow-Sphere Phantoms

We can use a hollow sphere phantom to measure contrast, defined as c=(l−b)/b, where l and b are radiopharmaceutical concentrations in the region of interest and the background, respectively. As is standard practice, we can determine l as the activity per unit volume in a region of interest (ROI) that is centered within and somewhat smaller than the hot/cold lesion, so as to limit overlap of the ROI with voxels that are only partially within the lesion (i.e., partial volume effects). Blurring causes l on average to underestimate (overestimate) for hot (cold) lesions the true structure concentration l^{T} and thus c to underestimate (overestimate) the true contrast c^{T}.

This bias in l can be reduced by choosing a smaller ROI, but generally at the cost of greater random fluctuations in l and thus inc. The background concentration b can be determined from a second ROI that is annular in shape and concentric with the first ROI to minimize the effect of non-uniform background.

The mean and variance of c can be estimated in several ways; we may use ensemble studies, conducted with lesion present and lesion absent as a comparative method for estimating background fluctuation. These studies can be conducted with and without collimation and with lesions of different sizes and true contrasts. We will also generate contrast-vs-noise curves, as in FIG. 12, where every iteration gives a different (noise, contrast) data point from the ensemble, to compare results at the same noise level.

### Count Rate

All studies at different count rates can be conducted to determine if that has an impact on results. For example, although collimation has a reduced sensitivity, its performance at high count rate may be enhanced because of reduced deadtime and reduced randoms.

Having described preferred embodiments of the invention with reference to the accompanying drawings, it is to be understood that the invention is not limited to the precise embodiments, and that various changes and modifications may be effected therein by those skilled in the art without departing from the scope or spirit of the invention as defined in the appended claims.

1. A collimation apparatus comprising:
a first ring comprising an array of crystals and a second ring comprising an array of radiation blocking elements, wherein said second ring is disposed inside said first ring, and
wherein a portion of each crystal of said array of crystals is blocked by a radiation blocking element of said array of radiation blocking elements.

2. The apparatus of claim 1, wherein at least half of each crystal of said array of crystals is blocked by a radiation blocking element of said array of radiation blocking elements.

3. The apparatus of claim 1, wherein said portion of each crystal of said array of crystals is blocked by said radiation blocking element in transverse direction, axial direction, or transverse-axial direction.

4. The apparatus of claim 1, wherein said crystal is a LaBr3 crystal.

5. The apparatus of claim 1, wherein said crystal is a lutetium Yttrium oxyorthosilicate (LYSO) crystal.

6. The apparatus of claim 1, wherein said crystal is a lutetium oxyorthosilicate (LSO) crystal.

7. The apparatus of claim 1, wherein said radiation blocking element is lead.

8. The apparatus of claim 1, wherein said radiation blocking element is tungsten or other lead-free radiation blocking element.

9. The apparatus of claim 1, wherein said collimation apparatus further comprising a mounting mechanism that facilitates mounting said collimation apparatus on a scanning apparatus.

10. The apparatus of claim 9, wherein said scanning apparatus is a positron emission tomography (PET) scanner.

11. The apparatus of claim 9, wherein said scanning apparatus is a single photon emission computed tomography (SPECT) scanner.

12. The apparatus of claim 9, wherein said collimation apparatus provides improved spatial resolution as well as improved sampling method for scanning a subject.

13. The apparatus of claim 12, wherein said sampling method comprises shifting said subject.

14. The apparatus of claim 12, wherein said sampling method comprises shifting said collimation apparatus.

15. The apparatus of claim 12, wherein said sampling method comprises rotating said collimation apparatus.

16. An imaging device comprising the apparatus of claim 1.

17. A positron emission tomography (PET) scanner comprising a collimation apparatus, said collimation apparatus comprising:
a first ring comprising an array of crystals and a second ring comprising an array of radiation blocking elements, wherein said second ring is disposed inside said first ring, and
wherein a portion of each crystal of said array of crystals is blocked by a radiation blocking element of said array of radiation blocking elements.

18-28. (canceled)

29. A method of fabricating a scanner of claim 17.

30. A method of fabricating a collimation apparatus comprising:
providing a first ring comprising an array of crystals; and
providing a second ring comprising an array of radiation blocking elements, said second ring disposed inside said first ring, wherein a portion of each crystal of said array of crystals is blocked by a radiation blocking element of said array of radiation blocking elements.

31-42. (canceled)

43. The method of claim 43, wherein at least half of each crystal of said array of crystals is blocked by a radiation blocking element of said array of radiation blocking elements.

44-57. (canceled)
